(19) United States
(12) Patent Application Publication
(10) Pub. No.: US 2003/0072359 A1
(43) Pub. Date: Apr. 17, 2003

(54) Method and apparatus for digital subscriber line transfer

(76) Inventors: Heikki Suonsivu, Espoo (FI); Veli Etelaniemi, Kirkkonummi (FI); Juri Sipila, Espoo (FI)

Correspondence Address: PILLSBURY WINTHROP, LLP, P.O. BOX 10500, MCLEAN, VA, 22102, US

(21) Appl. No.: 09/975,548

(22) Filed: Oct. 12, 2001

(51) Int. Cl. H04L 5/16; H04B 1/38

(52) U.S. Cl. 375/219

(57) ABSTRACT

VDSL (Very-high-data-rate Digital Subscriber Line) technology uses at least one downlink frequency band (D1, D2) for conveying information from a data network to a subscriber's transceiver unit. At some sites VDSL technology cannot be used because no standardized uplink frequency band (U1, U2) is usable. The invention solves this problem by using at least one non-VDSL uplink frequency band (N1) for conveying information from the subscriber's transceiver unit to the data network.

### BACKGROUND OF THE INVENTION

The invention relates to DSL (Digital Subscriber Line) technology, and more particularly, to a transceiver unit using DSL technology. DSL refers generally to a public network technology that delivers relatively high bandwidth over conventional telephone copper wiring at limited distances. A transceiver unit is the interface point between a data processing apparatus (such as a user's computer or the corresponding device in a switch or exchange) and a data network. DSL transceiver units may also be called DSL modems, but the term modem is somewhat misleading and is later restricted to telephony usage. A description of DSL technology and examples of DSL equipment can be found in U.S. Pat. No. 6,226,322 to Subahashish Mukherjee.

As stated by Mukherjee, there are many variations within the generic DSL concept, such as ADSL (Asymmetric DSL), SDSL (Single-Line DSL), HDSL (High-Bit-Rate DSL), and VDSL (Very-high-data-rate DSL). In addition, there are several proprietary acronyms. The acronym ‘XDSL’, where X means “any”, is frequently used to cover all of the above DSL implementations.

In terms of frequency usage, DSL technology is based on two alternative approaches, discrete multi-tone (DMT) and quadrature amplitude modulation (QAM). As suggested by its name, DMT technology relies on several discrete frequencies (tones) to carry information. To put it more precisely, DMT is actually a form of frequency-domain multiplexing. The input data stream is divided into N channels, each channel having the same bandwidth but a different center frequency. QAM technology, in contrast, uses broad, consecutive frequency bands, at least one band for downlink traffic and at least one band for uplink traffic. DMT technology has a high spectral efficiency but is difficult to implement. Downlink means a direction from a data network to a subscriber's transceiver unit, and uplink means the opposite direction.

A DSL equipment designer is constrained by standards. FIG. 1A illustrates the frequency bands currently allocated for VDSL and non-VDSL use. A first downlink band, denoted by reference sign D1, begins at 138 kHz and ends at 3 MHz (all frequencies are approximate). A first uplink band U1 begins at about 3 MHz and ends at about 5 MHz. A second downlink band D2 is located between 5 and 7 MHz, and a second uplink band U2 is located between 7 and 12 MHz. These frequencies are currently specified by respective ETSI standards, see for example ETSI TS 101 270-2, FIGS. 5 through 7 and table 1. As seen from FIG. 1A, the current VDSL standardization states that VDSL equipment only operate at frequencies above 138 kHz. In other words, frequencies below 138 kHz are allocated to other uses.

In FIG. 1A, the frequency bands D1, U1, D2 and U2 are allocated to VDSL use. In many subscriber locations only the first downlink and uplink bands D1 and U1 may be usable, as shown by the bold outline.

A problem associated with prior art DSL equipment is related to the fact that most of the existing telephone copper wiring was installed only for ordinary voice telephony or for modems operating in the kilohertz range. Accordingly, the range of VDSL equipment is limited to approximately 1 km plus or minus several hundred meters, and crosstalk from neighbouring wires makes transmission conditions unpredictable. It is usually the higher frequencies that are unusable. As seen from FIG. 1A, if the first uplink band U1 from 3 to 5 MHz is unusable, VDSL equipment cannot be used because there is no available uplink band.

There is no easy way of predicting whether any of the VDSL uplink bands are usable at a given subscriber location. Thus a network operator (or the subscribers themselves) must install a VDSL transceiver unit and see if it work at the location. In some situations, VDSL equipment cannot be used to reach a subscriber's premises because the distance to be covered exceeds the range of VDSL technology. This testing and the necessary stocking of many different types of equipment is time-consuming and expensive.

The above problem does not affect DMT-type equipment because DMT uses several discrete tones instead of broad continuous frequency bands. However, DMT technology is much more difficult to implement than non-DMT (single/dual carrier) technology.

### BRIEF DESCRIPTION OF THE INVENTION

An object of the present invention is to provide a method and an apparatus for implementing the method so as to alleviate the above disadvantages. In other words, the invention should approach the high spectral efficiency of DMT technology without inherent implementation difficulties.

The object of the invention is achieved by a method and an arrangement which are characterized by what is stated in the independent claims. The preferred embodiments of the invention are disclosed in the dependent claims.

The invention is based on the idea of using a frequency band that is normally allocated to non-VDSL use in a transceiver unit that otherwise follows current VDSL conventions. In other words, a transceiver unit according to the invention is equipped to use at least some frequency bands that are normally allocated to VDSL plus an uplink band that is normally allocated to non-VDSL use. If the copper wiring to the subscriber premises support at least one conventional VDSL band in each direction, the standardized VDSL bands will be used, and the transceiver unit according to the invention operates like a conventional VDSL transceiver unit. The benefits of the invention are especially apparent if the copper wiring fails to support conventional VDSL bands in each direction (typically, no uplink band would be available). In such a case, uplink is transmitted on the band below 138 kHz that is normally allocated to non-VDSL use. Naturally, such a non-VDSL uplink band has much less capacity than any of the conventional VDSL uplink bands that are normally allocated to VDSL, but at a location where conventional VDSL technology is unusable, the technique according to the invention is a definite improvement over other available situations. This is because downlink transfer typically requires more bandwidth than uplink transfer, and at least the first VDSL downlink band from (138 kHz to approximately 3 MHz) is available for downlink transfer.

In other words, the invention is partially based on the discovery of serious limitations in current VDSL standardization. These limitations practically prevent the use of VDSL technology if the standardized VDSL uplink frequency band from approximately 3 MHz to approximately 5 MHz is unavailable for uplink transfer. Accordingly, an advantage of the invention is that, for some subscribers, VDSL technology is available for downlink transfer albeit with reduced capacity for uplink transfer.

However, the primary problem underlying the invention is not expansion of VDSL coverage, because VDSL coverage could be expanded by DMT technology. Rather the primary problem is elimination of the costs and complexities incurred by DMT technology. Further reduction of costs and complexities can be obtained by suitable filter construction. A VDSL transceiver unit comprises a digital part and an analogue part. The analogue part comprises filters that in conventional VDSL transceiver units are high-pass and low-pass filters. According to of a preferred embodiment of the invention, the first standardized VDSL downlink band D1 is implemented by a bandpass filter for downlink transfer and as a bandstop filter for uplink transfer.

Alternatively, a transceiver unit may use both the standardized uplink band U1, or bands U1 and U2 as the case may be, and the non-VDSL uplink band according to the invention, for higher uplink capacity.

According to another preferred embodiment of the invention, the transceiver unit is able to negotiate with its peer entity to learn what frequency bands are usable. Conventional POTS (“plain old telephone system”) modems use negotiation because a modem does not know what kind of a modem it is communicating with. VDSL transceiver units are different, however, because a subscriber's transceiver unit always communicates via the same network element that comprises its peer entity. Accordingly, a negotiation over the available frequency bands seems like an added complexity and a waste of time. On closer look a negotiation phase may prove useful, however, because situations may change, and added flexibility is welcome.

### BRIEF DESCRIPTION OF THE DRAWINGS

In the following the invention will be described in greater detail by means of preferred embodiments with reference to the attached drawings, in which

FIG. 1A illustrates the frequency bands currently allocated for VDSL and non-VDSL use;

FIG. 1B illustrates the frequency bands used by a transceiver unit according to the invention;

FIG. 2 schematically illustrates how the invention expands the use of VDSL technology; and

FIG. 3 shows the location of VDSL transceiver units;

FIGS. 4 to 8 show alternative filter constructions for filtering the uplink frequency bands.

### DETAILED DESCRIPTION OF THE INVENTION

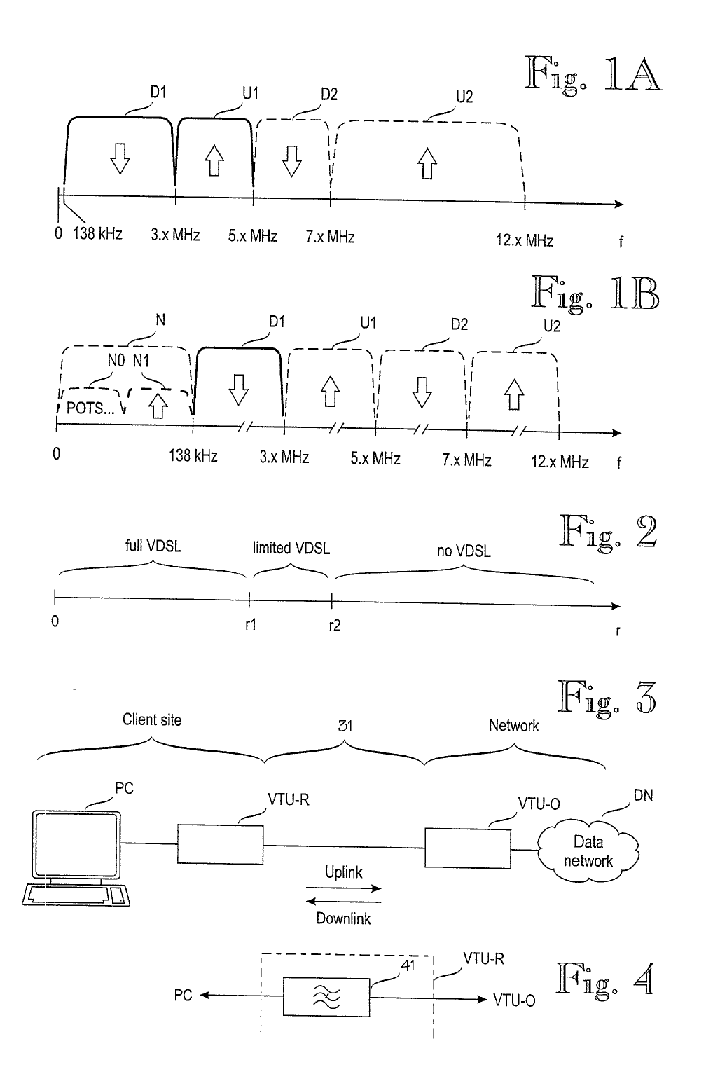

FIG. 1B illustrates the frequency bands used by a transceiver unit according to the invention. Note that in FIG. 1A the frequency axis f was drawn to scale, whereas in FIG. 1B, the lower end of the frequency spectrum is very much exaggerated. In FIG. 1B, reference sign N denotes a frequency band allocated to non-VDSL use by current VDSL standards. For example, the non-VDSL band N comprises frequencies used by conventional telephony, or POTS, signals. These frequencies are denoted by reference sign N0. According to the invention, a transceiver unit is capable of using a part of the non-VDSL band N for uplink use, at least in a situation where no other uplink bands are usable. In FIG. 1B, such an uplink band that is currently allocated to non-VDSL use is denoted by reference sign N1. Again, bold outlines show frequency bands that are actually available. In the situation illustrated by FIG. 1B, none of the standardized VDSL uplink bands U1 or U2 are available. The non-VDSL uplink band N1 is shown by a bold dashed line, which means that the band is available but not allocated to VDSL use by current standardization.

One should keep in mind that in FIG. 1B the band denoted by reference N is shown very much exaggerated compared with the conventional VDSL bands D1, U1, D2 and U2. The conventional VDSL bands span at least two megahertz each. The uplink band N1 according to the invention spans approximately 0.1 megahertz. In other words, if the conventional VDSL uplink bands are unusable, a transceiver unit according to the invention has a wide discrepancy between its downlink and uplink capacities, the uplink capacity being less than 5 percent of the downlink capacity. However, for some applications, such as file download, video-on-demand and web surfing, the discrepancy is tolerable.

FIG. 2 schematically illustrates how the invention expands the use of VDSL technology. The horizontal axis r represents range or radius from a network switch or exchange. Up to a radius r1, full VDSL support is available, meaning at least one each of the conventional uplink and downlink bands (denoted by U1 and D1 in FIG. 1A). Without the invention, locations beyond radius r1 could not be covered by VDSL technology. With a transceiver unit according to the invention, locations between radii r1 and r2 can be covered with limited VDSL support, meaning that at least one of the conventional VDSL downlink bands (e.g. D1) is available plus the non-VDSL-allocated uplink band N1 shown in FIG. 1B. Beyond radius r2, no VDSL coverage is available because the uplink band U1 is unusable. At a typical site, the radius r1 is between 1000 and 2000 meters, and r2 is approximately same as with the current ADSL solutions, i.e. several kilometres, depending greatly on the general conditions of the copper. Naturally, the radii r1 and r2 are measured along the wiring, and in a cable duct with much crosstalk between individual cables, the radii are shorter than in a cable duct with less crosstalk.

FIG. 3 shows the location of VDSL transceiver units. A client site comprises a personal computer PC. If the client site comprises several computers PC, they may be interconnected by a local area network (not shown separately). The client site equipment, such as the computer PC, is connected to VDSL transceiver unit known as a VTU-R (VDSL transceiver unit at a remote site). Its peer entity in the telecommunications network is called a VTU-O (VTU at an Optical network unit). The VTU-O is typically located at a network switch or exchange. The span 31 between the VTU-R and the VTU-O is informally called “the last mile”.

An optimal embodiment of a transceiver unit according to the invention implements all the standardized VDSL bands D1, U1, D2 and U2 plus the non-VDSL band N1. Additionally, the optimal embodiment is also able to negotiate with its peer entity over the actually available frequency bands. Such a transceiver unit gives virtually all the benefits of a DMT unit but is much simpler to construct. Network operators or equipment vendors do not have to stock other types of VDSL transceiver units, or change subscriber units when line conditions change.

### Handshake Procedure and Activation

Let us now discuss handshake (negotiation) procedures and activation of individual frequency bands. Current ETSI VDSL standardization (see e.g. ETSI TS 101 270-2, section 7.5.2.1) requires that a VTU-R transmit an IDLE message before it detects a COMMAND-type message transmitted by a VTU-O. The VTU-R unit estimates the power of the received signal. The signal power provides an estimate as to whether the standard uplink bands are usable. If some of them are usable, the handshake procedure and link activation given in the ETSI standard will be followed. The VTU-O determines which of the uplink bands will be used.

If the VTU-R finds that none of the standard uplink bands are usable, the handshake procedure is performed using the N1 band.

In a borderline case, the U1 band may initially appear usable but proves to be unusable, however. In a case where link activation using the U1 band fails, if the VTU-R returns three times to the ‘Cold Start’ state defined in FIG. 49 of the ETSI standard, or the Cold Start fails, the VTU-R will change the applied band to N1. If link activation using the N1 band fails too, the VTU-R will change the applied band back to U1. This way, the VTU-R will periodically change the applied band. This procedure involves that the timing diagram of the VTU-O and VTU-R will be different. To allow for the multiple attempts, the maximum timeout, known as T1 in the ETSI standard, should be lengthened at the VTU-O.

The above problems affect only single-band transceivers. If a VTU-R transceiver is able to transmit simultaneously at the U1 and N1 bands, it may use either band. A VTU-O unit that is capable of receiving signals from more than one band simultaneously may listen to both bands. When the VTU-O receives a signal from one band only, the band is changed from U1 to N1 or vice versa each time when the Cold Start fails.

### Optional Filter Constructions

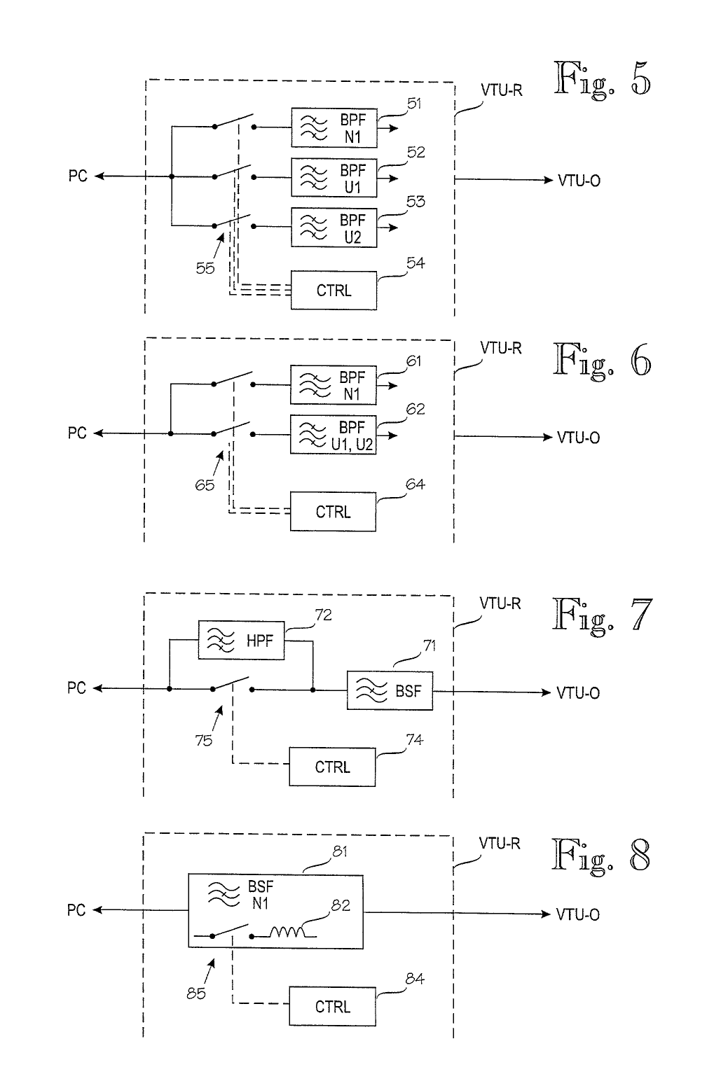

FIGS. 4 to 8 show alternative filter constructions for filtering the uplink frequency bands at a VTU-R unit. For the purposes of clarity, only the uplink filters are shown, because downlink filters can be entirely conventional. FIG. 4 shows a very simple filter construction in which the VTU-R employs a single bandstop filter 41. VDSL technology uses higher frequencies than older DSL technology does. Noise from the old-technology DSL signals can be removed by suitably-selected high-pass filters. However, the N1 band is not a standard VDSL band, and noise from this band may increase distortion in uplink bands if a bandstop filter is applied. Noise from this band can be filtered by several techniques. FIG. 5 shows, by way of example, an embodiment in which multiple bandpass filters are used instead of bandstop filters. There is a separate bandpass filter 51 to 53 for each of the N1, U1 and U2 bands. A control unit 54 enables or disables the bandpass filter 51 to 53 by means of switches 55. FIG. 6 shows a filter construction comprising one bandpass filter 61 for the N1 band and another bandpass filter 62 that is common to the U1 and U2 bands. Switches 65 disable the filter 61 when the N1 band is not used. FIG. 7 shows a third filter construction, in which an extra low-order high pass filter 72 is located in series with a filter combination. The cut-off frequency of the filter 72 lies between the maximum frequency of the N1 band and the minimum frequency of the U1 band. This extra filter is enabled when the N1 band is not used. As a fourth alternative, FIG. 8 shows an embodiment in which a bandstop filter 81 is designed such that switchable coils 82 enable the use of the N1 band. When these coils are removed, by means of a switch 85, the filter acts 81 as a high-pass filter. By selectively switching the coils on or off, it is possible to enable or disable the use of the N1 band.

While configuring a VDSL transceiver, it is possible to enable or disable the use of the N1 band. If the N1 band is enabled but not used after a handshake procedure, the VTU-O may switch off noise from the N1 band using the above-described filters or filter combinations. When the VTU-O returns back to Cold Start state, it may again enable the use of the N1 band if that band was previously disabled. This procedure lets the VTU-O determine whether the non-standard N1 band is in use.

It is readily apparent to a person skilled in the art that, as the technology advances, the inventive concept can be implemented in various ways. The invention and its embodiments are not limited to the examples described above but may vary within the scope of the claims.

### Acronyms

### (Some Are Not Official)

ETSI: (European Telecommunications Standards Institute)

VTU: VDSL Transceiver Unit

VTU-O: VTU at an Optical network unit

VTU-R: VTU-Remote Terminal

U1, U2: first/second standardized uplink bands

D1, D2: first/second standardized downlink bands

N: non-standard band (band not normally allocated to VDSL)

N0: band normally allocated to POTS

N1: portion of the N band allocated to VDSL

T1: timeout

We claim:

1. A method for conveying information between a data network (DN) and a subscriber's transceiver unit (VTU-R), the method comprising:
using at least one Very-high-data-rate Digital Subscriber Line, or VDSL, downlink frequency band (D1, D2) for conveying information from the data network to the subscriber's transceiver unit; and
using at least one non-VDSL uplink frequency band (N1) for conveying information from the subscriber's transceiver unit to the data network.

2. A method according to claim 1, further comprising using the at least one non-VDSL uplink frequency band (N1) only if no VDSL uplink bands U1, U2) are usable

3. A method according to claim 1, further comprising using the at least one non-VDSL uplink frequency band (N1) even at least one VDSL uplink band (U1, U2) is usable.

4. A method according to claim 1, further comprising the transceiver unit negotiating with its peer entity as to whether at least one VDSL uplink band (U1, U2) is usable.

5. A transceiver unit (VTU-R) for Very-high-data-rate Digital Subscriber Line, or VDSL, communication to/from a data network (DN) the transceiver unit comprising:
downlink filter means for using at least one Very-high-data-rate Digital Subscriber Line, or VDSL, downlink frequency band (D1) for conveying information from the data network to the subscriber's transceiver unit; and
uplink filter means (41, 51-53, 61-62, 71-72, 82) for using at least one non-VDSL uplink frequency band (N1) for conveying information from the subscriber's transceiver unit to the data network.

6. A transceiver unit according to claim 5, further comprising uplink filter means (52-53, 62) for using at least one VDSL uplink frequency band (U1, U2).

7. A transceiver unit according to claim 5, wherein the uplink filter means comprises a bandstop filter (41) for implementing the non-VDSL uplink frequency band (N1).

8. A transceiver unit according to claim 6, wherein the uplink filter means comprises a first bandpass filter (61) for the non-VDSL uplink band (N1) and at least one second bandpass filter (52-53; 62) for at least one VDSL uplink frequency band (U1, U2).

9. A transceiver unit according to claim 8, wherein the uplink filter means comprises a separate bandpass filter (52-53) for each VDSL uplink frequency band.

10. A transceiver unit according to claim 6, wherein the uplink filter means comprises a bandstop filter (41, 71, 81).

11. A transceiver unit according to claim 10, further comprising a switchable high-pass filter (72) in series with the bandstop filter (71).

12. A transceiver unit according to claim 10, wherein the bandstop filter (81) comprises at least one switchable coil (82).

13. A transceiver unit according to claim 5, wherein the non-VDSL uplink frequency band (N1) has an upper limit of approximately 138 kHz.

14. A transceiver unit according to claim 5, further comprising means for negotiating with its peer entity as to whether at least one VDSL uplink band (U1, U2) is usable.
